(19) United States
(12) Patent Application Publication
(10) Pub. No.: US 2017/0341965 A1
(43) Pub. Date: Nov. 30, 2017

(54) METHOD FOR PRODUCING A GLASS PRODUCT AND GLASS PRODUCT OBTAINED BY THE METHOD

(71) Applicant: SCHOTT AG, Mainz (DE)

(72) Inventors: Olaf Claussen, Undenheim (DE); Maria-Louisa Reich, Frankfurt am Main (DE); Thomas Pfeiffer, Ingelheim (DE); Guenter Weidmann, Flonheim (DE)

(73) Assignee: SCHOTT AG, Mainz (DE)

(21) Appl. No.: 15/609,404

(22) Filed: May 31, 2017

(30) Foreign Application Priority Data
May 31, 2016 (DE) 102016109974.0

(51) Int. Cl. C03B 5/225

(52) U.S. Cl. CPC C03B 5/2252

(57) ABSTRACT

A method for producing a glass product having a low bubble content from a melt is provided, wherein the melt at least partly comes into contact with a noble metal-comprising component.

### CROSS REFERENCE TO RELATED APPLICATIONS

This application claims the benefit under 35 U.S.C. 119 of German Application No. 102016109974.0 filed on May 31, 2016, the entire contents of which are incorporated by reference herein.

### BACKGROUND

### 1. Field of the Invention

The invention relates to a method for producing a glass product. A further aspect of the invention relates to a glass product obtained by such method.

### 2. Description of Related Art

Processes for producing glass products have been known for many years. While in the early days of industrial glass production it was still difficult to achieve adequate reproducibility of the glass properties, for example, or to produce glasses without toxic substances, for example without lead, these processes are now well-established industrially. In this way it is possible to produce glass products which even satisfy the high requirements in the pharmaceutical or chip industry, for example.

Nevertheless, there are still a number of fundamental problems today, arising from the nature of the glasses themselves and from the associated high production temperatures. One such problem, for example, is the interaction of a glass melt with the materials surrounding it. For example, a reaction of the glass melt with the trough material may be caused, resulting in a partial dissolution of the trough and a local change in the melt, or else in a reaction of the glass melt with the material of the drawing nozzles.

Particularly undesirable is a reaction of the glass melt with those materials which comprise noble metal. Each glass melt comprises a certain amount of water, and this water may be present in dissolved molecular form, but also as OH groups bound to individual melt components, or, due to the intrinsic dissociation of the water as dissolved ions which are usually referred to as hydroxide ions (OH⁻) and hydroxonium ions (H₃O⁺). If such a glass melt comes into contact with a noble metal-comprising component, it may then happen that the oxygen concentration in the glass melt exceeds a critical value, the so-called saturation concentration.

In summary, this can be described by the following redox reaction according to which water is decomposed into its individual components:

2H₂O⇄2H₂+O₂ (1)

Since noble metals, for example platinum, exhibit high permeability to hydrogen, the hydrogen can diffuse out of the melt through the noble metal-comprising components. This has two consequences:

Due to the withdrawal of a product, in the present case hydrogen, H₂, the equilibrium of reaction (1) is shifted to the right-hand side of the reaction equation. This results in a local depletion of hydrogen and an increase of oxygen in the melt.

If the produced oxygen is no longer chemically bound by polyvalent elements (for example refining agents such as SnO₂) (2 SnO+O₂ [symbol] 2 SnO₂), gas bubbles will occur at these sites.

If these gas bubbles enter the end product, the yield will be drastically reduced.

The underlying reaction (1) for the mechanism of water decomposition and hence local formation of gas bubbles in the melt initially appears very simple, but in practice it is difficult to be controlled or described, since the decomposition of water in a glass melt is influenced by a great number of factors, in particular by the: water content and solubility of water in the melt; type of the one or more noble metal(s) with which the melt comes into contact; thickness of the noble metal-comprising component; temperature and dwell time of the glass at the interface between noble metal-comprising component and the glass; redox state of the glass; type and content of the redox-active components (e.g. refining agents, such as SnO₂) in the glass melt; composition of the atmosphere on the side of the noble metal-comprising component facing away from the glass.

In order to avoid the occurrence of gas bubbles in the end product, several measures are appropriate. For example, particularly low-water raw materials can be used, or redox-active components can be added to the glass melt, for example tin oxide. Also, the temperature of the glass melt or the dwell time on the noble metal-comprising component may be adjusted so that no bubbles will arise.

However, there are some limits to each of these measures, for example when a high-viscosity glass is melted, which due to the high melt viscosity will have a dwell time on the noble metal-comprising component that cannot be reduced to below a critical dwell time. The addition of redox-active substances may lead to the formation of detrimental components in the melt. If bubble formation occurs at the outlet of the melting unit, it is moreover not readily possible to adjust a temperature which is known to cause no decomposition of the water in the melt, since certain requirements in terms of melt viscosity and hence temperature have to be met for the shaping of a glass. In such cases, measures have to be taken which reduce or even completely prevent the mechanism of water decomposition and therefore the formation of gas bubbles on the noble metal-comprising component.

For example, it has been proposed to provide a hydrogen-containing gas on the side of the noble metal-comprising component which faces away from the glass melt, for example by having the component flushed by the hydrogen-containing gas on the side facing away from the glass melt. This is in particular necessary because a location-resolved detection of the locations at which hydrogen diffuses through the noble metal-comprising component is not possible.

International patent application WO 98/18731 A2, for example, describes that the side facing away from the glass melt of a component which contains platinum, molybdenum, palladium, rhodium, and alloys of these metals, for example of a container in which a glass is melted, is exposed to a controlled water vapor partial pressure. In this way, diffusion of molecular hydrogen through a platinum component, for example, is reduced.

This is because in this case water will also be decomposed into its constituents on the outer side of the noble metal-comprising component. The resulting hydrogen H₂ now prevents diffusion of the hydrogen from the melt to the outside. However, now, a reaction of the oxygen of initially radical nature with the noble metal may occur, for example so that a platinum oxide, PtO₂, is formed. However, these noble metal oxides are volatile, so that the wall thickness of the noble metal-comprising component will continually be reduced due to such reactions.

A further possibility for reducing or avoiding the diffusion of hydrogen through noble metal-comprising components is to provide hydrogen on the side of the component facing away from the glass melt. However, if the noble metal-comprising component is completely flushed, the hydrogen will now diffuse into the glass melt from outside at locations where the concentration of hydrogen in the glass melt is lower than outside. Thus, certain constituents in the melt will locally be reduced by the hydrogen, for example iron which is present in the melt as an impurity and which will then exist in elemental form and will locally alloy the noble metal. However, this also results in reduced mechanical resistance of the component and may moreover lead to chemical reactions which result in a formation of particles or bubbles, for example, which is likewise undesirable.

In order to reduce hydrogen diffusion, it is furthermore possible to increase the wall thickness of the noble metal-comprising component. However, because of the high cost of noble metals this is associated with significantly higher financial expenses and is therefore unfavorable.

The noble metal-comprising component may moreover be coated on the side facing away from the glass melt.

Furthermore, there is the principle of so-called glazing. In this case, a glass melt is applied also onto the side facing away from the glass melt. However, in particular at mechanically highly stressed points of a melting unit sufficient support of such structures is not possible, so that the mechanical service life of the noble metal-comprising component is likewise reduced in this way.

Thus, although there are a number of approaches for reducing hydrogen diffusion through a noble metal-comprising component, they still have a number of drawbacks. What is lacking, therefore, is a simple and inexpensive method for producing glass products from a melt, in which bubble formation due to water decomposition is reduced or even completely suppressed and in which detrimental side reactions do not occur.

### SUMMARY

It is an object of the invention to provide a method for producing a glass product that has a low bubble content as well as a glass product obtained by such method.

The present method is a method for producing a glass product having a low bubble content from a melt, which melt comes into contact, at least partly, with a component that comprises a noble metal. Both the concentration and the activity of the chemically and physically dissolved oxygen are decisive for a new formation of O₂ bubbles. Therefore, the value of the oxygen partial pressure p(O₂) in the glass melt is used to describe a potential risk of O₂ bubble formation. Thus, the melt exhibits a temperature-dependent oxygen partial pressure, which oxygen partial pressure may vary or varies locally over the volume of the melt. At locations of the noble metal-comprising component which are in contact with the melt and where the oxygen partial pressure locally reaches critical values, in particular where the pO₂ locally increases up to a critical value between 0.8 bar and 1.2 bar, preferably between 0.9 bar and 1.1 bar, at least one of the following measures is implemented, only locally, on the noble metal-comprising component: the side of the noble metal-comprising component which faces away from the melt is coated, in particular with a glass; the side of the noble metal-comprising component which faces away from the melt is exposed to a water-containing atmosphere, in particular to a water-containing protective gas atmosphere, (e.g. N₂, noble gas etc.); or the thickness of the component is increased.

Usually, the concentration of chemically dissolved oxygen is many times higher than that of physically dissolved oxygen. Chemically dissolved oxygen generally refers to the oxygen which is bound to polyvalent elements, such as tin (SnO and SnO₂) or iron (FeO and Fe₂O₃), for example. The following equation applies to such a polyvalent element and the relevant oxygen:

2SnO₂ [symbol] 2SnO+O₂ (2)

For this reaction, a corresponding equilibrium constant K can be formulated according to the law of mass action, for which the activities of the individual components are considered. Since the polyvalent elements and the chemically bound oxygen are usually present in low concentrations, the concentrations are used for SnO₂ and SnO, and for the oxygen the corresponding partial pressure is used:

K(T)=[SnO]*pO₂^{1/2}/[SnO₂] (3)

Since the equilibrium constant K changes with temperature, the pO₂ of the melt will also change correspondingly, without necessarily changing the [SnO]/[SnO₂] ratio.

If now, due to the decomposition of water, O₂ is produced at the interface between noble metal-comprising component and glass (at a constant temperature), the proportion of [SnO₂] will increase according to equation (2), and the proportion of [SnO] will decrease. Since at constant temperature the equilibrium constant remains unchanged, the oxygen partial pressure pO₂ must therefore increase simultaneously with an increasing concentration of SnO₂.

This increase in the oxygen partial pressure becomes critical when the pressure is finally high enough so that new bubbles are formed.

In the context of the present invention, noble metal refers to a metal selected from the following list: platinum, rhodium, iridium, osmium, rhenium, ruthenium, palladium, gold, silver, and alloys of these metals.

In the context of the present invention, a component is referred to as a noble metal-comprising component when it comprises at least one metal from the above list in a significant amount, that means with a content that exceeds unavoidable traces, in particular at least 0.1 percent by weight.

The glass melts of the present invention comprise oxidic melts. As far as the oxygen concentration of the melt is discussed in the context of the present invention, it refers to the concentration of oxygen present in the melt in dissolved form, unless expressly stated otherwise. The other oxygen content, that means the content of oxygen which is present in the melt for instance in the form of ions or bound to other elements such as silicon, for example in the form of complexes, is not comprised by the term oxygen concentration of the melt, unless expressly stated otherwise.

The number of bubbles to be achieved can only be compared for different products if the number of bubbles per kilogram is known. In the case of sheet glass, the indication “bubbles/m²” is often used, and for tubes the indication “bubbles/10 m” tube.

Furthermore, rejects due to bubbles differ from product to product. For lightweight products with a weight of 100 g, for example, and in the case of one bubble per kilogram, this would lead to calculated 10% of rejects of the produced products, whereas in the case of a product having a weight of 5 kg, one bubble per kilogram could already lead to a total reject.

The so-called bubble number, i.e. the indication of bubbles per kg, should generally be less than 10 bubbles per kg, preferably less than one bubble per kg, and more preferably less than 0.1 bubble per kg (or less than one bubble per 10 kg). As a generally applicable rule, for higher product weights and stricter specifications the number of bubbles must be lower, as stated above.

Preferably, a two-stage process is performed according to the method, wherein in a first step the locations at the noble metal-comprising component are identified where the local oxygen partial pressure reaches critical values, i.e. where it reaches about 1 bar, in particular where the pO₂ locally increases up to a critical value between 0.8 bar and 1.2 bar, preferably between 0.9 bar and 1.1 bar, and then, once these locations have been identified, a countermeasure is implemented only locally in order to prevent formation of oxygen bubbles.

Usually, an only local determination of the oxygen concentration is very difficult to implement by measurement techniques. Therefore, it is advantageous to rely on the technique of simulation. In order to be able to perform such a simulation, the following steps are therefore necessary: establishing an electrochemical model which includes all relevant parameters relating to the decomposition of water and their effects on the oxygen partial pressure pO₂ at the interface component-glass; determining the necessary characteristic data by suitable laboratory experiments; and transferring the electrochemical model including the characteristic data and the given process parameters into a suitable simulation tool.

According to a further embodiment of the invention, the local oxygen partial pressure, pO₂, is between 0.8 and 1.2 bar, preferably between 0.9 and 1.1 bar.

According to a further embodiment of the invention, the noble metal-comprising component comprises a stirring crucible having a tubular inlet and an outlet, and the measure is implemented at the inlet and/or at the outlet.

Preferably, the component comprises one of the following noble metals and/or a mixture or alloy of the following noble metals: platinum, rhodium, iridium, osmium, rhenium, ruthenium, palladium, gold, silver.

According to a further embodiment of the invention, a dew point between 20° C. and 90° C. is adjusted in the water-containing atmosphere.

Preferably, the water-containing atmosphere does not comprise oxygen, except for unavoidable traces. In particular, the pO₂ of the water-containing atmosphere is less than 0.1 bar, preferably less than 0.01 bar, and particularly preferably less than 0.001 bar.

According to the method, different glass products can be produced. The method is therefore not limited to specific shaping techniques. Thus, the glass product in particular comprises a glass tube, a glass rod, or a sheet glass. Therefore, according to one embodiment of the invention, a glass tube, a glass rod, or a sheet glass is produced as the glass product.

The glass processed according to the invention preferably comprises a borosilicate glass, for example an alkaline earth-free or an alkaline earth-containing borosilicate glass, for example glasses which are marketed under the brand names Duran or Fiolax, or an alkaline earth aluminosilicate glass or a glass which is commercially available under the name Suprax. It is also possible to produce alkali-alkaline earth silicate glasses. Boron-free glass glasses, in particular boron-free neutral glasses, can also be produced according to the invention. Preferably, for example, boron-free or low-boron glasses are produced in particular in the form of glass tubes which are used for producing pharmaceutical packages. Low-alkali or alkali-free glasses can also be processed according to the method. The method is furthermore particularly suitable for producing low-arsenic, preferably arsenic-free glasses.

Thus, according to a further embodiment of the invention, the produced glass is a borosilicate glass, for example an alkaline earth-free or an alkaline earth-containing borosilicate glass, or an alkali-alkaline earth silicate glass, or a boron-free glass, in particular a boron-free neutral glass, or a low-alkali glass, preferably an alkali-free glass, or a low-arsenic glass, preferably an arsenic-free glass.

As far as the term “-free” is used in the context of the present invention, this means that the component in question is contained in the glass only in the form of unavoidable traces, for example due to impurities. This unavoidable trace content is below 0.1 mol %.

### EXAMPLES

In the following list, some exemplary glass compositions and composition ranges are listed (in percent by weight, wt %), which can be prepared using the method according to the invention.

### Exemplary Embodiment 1

A first exemplary composition, in wt %, of a glass which can be produced by the method according to the invention is given as follows:

| | |
|---|---|
| SiO₂ | 30 to 85 |
| B₂O₃ | 3 to 20 |
| Al₂O₃ | 0 to 15 |
| Na₂O | 3 to 15 |
| K₂O | 3 to 15 |
| ZnO | 0 to 12 |
| TiO₂ | 0.5 to 10 |
| CaO | 0 to 0.1. |

### Exemplary Embodiment 2

An exemplary glass composition, in wt %, within the composition range listed under Exemplary Embodiment 1 is as follows:

| | |
|---|---|
| SiO₂ | 64.0 |
| B₂O₃ | 8.3 |
| Al₂O₃ | 4.0 |
| Na₂O | 6.5 |
| K₂O | 7.0 |
| ZnO | 5.5 |
| TiO₂ | 4.0 |
| Sb₂O₃ | 0.6 |
| Cl⁻ | 0.1. |

### Exemplary Embodiment 3

Another exemplary composition range, in wt %, is as follows:

| | |
|---|---|
| SiO₂ | 58 to 65 |
| B₂O₃ | 6 to 10.5 |
| Al₂O₃ | 14 to 25 |
| MgO | 0 to 3 |
| CaO | 0 to 9 |
| BaO | 3 to 8 |
| ZnO | 0 to 2, |

wherein a total of the amounts of MgO, CaO, and BaO is in a range from 8 to 18 wt %.

### Exemplary Embodiment 4

An exemplary glass composition, in wt %, within the composition range listed under Exemplary Embodiment 3 is as follows:

| | |
|---|---|
| SiO₂ | 61 |
| B₂O₃ | 10 |
| Al₂O₃ | 18 |
| MgO | 2.8 |
| CaO | 4.8 |
| BaO | 3.3. |

### Exemplary Embodiment 5

Another exemplary glass composition, in wt %, is as follows:

| | |
|---|---|
| SiO₂ | 69 +/− 5 |
| Na₂O | 8 +/− 2 |
| K₂O | 8 +/− 2 |
| CaO | 7 +/− 2 |
| BaO | 2 +/− 2 |
| ZnO | 4 +/− 2 |
| TiO₂ | 1 +/− 1. |

### Exemplary Embodiment 6

Yet another exemplary glass composition, in wt %, is as follows:

| | |
|---|---|
| SiO₂ | 80 +/− 5 |
| B₂O₃ | 13 +/− 5 |
| Al₂O₃ | 2.5 +/− 2 |
| Na₂O | 3.5 +/− 2 |
| K₂O | 1 +/− 1. |

### Exemplary Embodiment 7

Yet another exemplary glass composition, in wt %, is as follows:

| | |
|---|---|
| SiO₂ | 75 |
| B₂O₃ | 10.5 |
| Al₂O₃ | 5 |
| Na₂O | 7 |
| CaO | 1.5. |

### Exemplary Embodiment 8

Another exemplary composition range, in wt %, is as follows:

| | |
|---|---|
| SiO₂ | 65 to 75 |
| Al₂O₃ | 11 to 18 |
| MgO | 5 to 10 |
| CaO | 5 to 10, |

with the glass containing no B₂O₃, SrO, BaO, CeO₂, and PbO, except for unavoidable traces, and containing not more than 0.1 wt % of alkali oxides.

### Exemplary Embodiment 9

Yet another exemplary composition range, in wt %, is as follows:

| | |
|---|---|
| SiO₂ | 50 to 65 |
| Al₂O₃ | 15 to 20 |
| B₂O₃ | 0 to 6 |
| Li₂O | 0 to 6 |
| Na₂O | 8 to 15 |
| K₂O | 0 to 5 |
| MgO | 0 to 5 |
| CaO | 0 to 7, preferably 0 to 1 |
| ZnO | 0 to 4, preferably 0 to 1 |
| ZrO₂ | 0 to 4 |
| TiO₂ | 0 to 1, preferably substantially |
| | free of TiO2. |

Furthermore, the glass may contain from 0 to 1 wt % of P₂O₅, SrO, BaO; and from 0 to 1 wt % of refining agents SnO₂, CeO₂, or As₂O₃, or other refining agents.

### Exemplary Embodiment 10

Yet another exemplary glass composition, in wt %, is as follows:

| | |
|---|---|
| SiO₂ | 72 |
| B₂O₃ | 11.5 |
| Al₂O₃ | 6.8 |
| Na₂O | 6.5 |
| K₂O | 2.4 |
| CaO + MgO | 0.7. |

### Exemplary Embodiment 11

Yet another exemplary glass composition, in wt %, is as follows:

| | |
|---|---|
| SiO₂ | 73 |
| B₂O₃ | 11.2 |
| Al₂O₃ | 6.8 |
| Na₂O | 6.8 |
| K₂O | 1.2 |
| CaO + MgO | 1.0. |

### Exemplary Embodiment 12

Yet another exemplary glass composition, in wt %, is as follows:

| | |
|---|---|
| SiO₂ | 80 |
| B₂O₃ | 12.7 |
| Al₂O₃ | 2.6 |
| Na₂O | 4.3 |
| K₂O | 0.1 |
| CaO + MgO | less than 0.1. |

### Exemplary Embodiment 13

Yet another exemplary glass composition, in wt %, is as follows:

| | |
|---|---|
| SiO₂ | 69 |
| B₂O₃ | 10 |
| Al₂O₃ | 6 |
| Na₂O | 6 |
| K₂O | 2 |
| CaO + MgO | 1 |
| Fe₂O₃ | 1 |
| BaO | 1.5 |
| TiO₂ | 3. |

Unless not already listed, all the exemplary embodiments mentioned above may optionally contain refining agents from 0 to 1 wt %, such as for example SnO₂, CeO₂, As₂O₃, Cl⁻, F⁻, and/or sulfates.

### BRIEF DESCRIPTION OF THE DRAWINGS

The invention will now be explained in more detail with reference to drawings, wherein:

FIG. 1 schematically illustrates water decomposition at the interface between noble metal-comprising component and glass;

FIG. 2a shows local critical oxygen partial pressures for the transition region from the trough to the crucible and in the crucible for a specific production system;

FIG. 2b shows local oxygen partial pressures as contour lines for the transition region from the trough to the crucible and in the crucible for a specific production system; and

FIG. 3 shows the profile of oxygen partial pressure at the component-crucible interface when flushed with different carrier gases.

### DETAILED DESCRIPTION

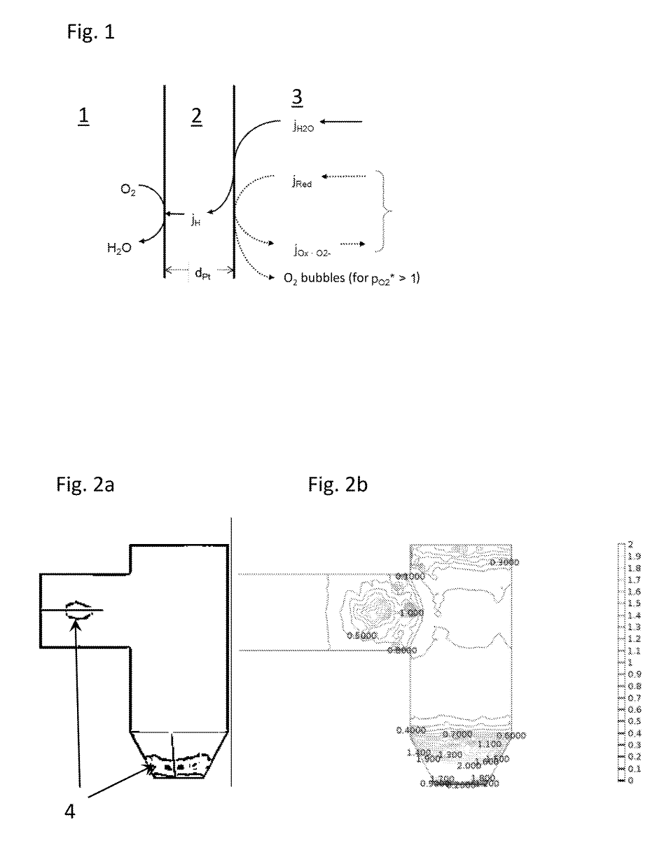

FIG. 1 schematically illustrates the process of water decomposition at the interface between a component comprising noble metal and a glass melt. Both thermodynamic and kinetic factors must be considered.

By way of example, the gas chamber 1 located on the side of the noble metal-comprising component 2 facing away from the glass melt is illustrated on the left, and also illustrated is the zone of glass melt 3. For example, the noble metal-comprising component may comprise platinum or may be made of platinum.

In terms of thermodynamics, the driving force of water decomposition is determined by the contents of oxygen and water, both in the gas and in the melt. The locally prevailing actual oxygen partial pressure is thereby substantially influenced by the diffusion properties of the relevant components in the glass melt, for example the redox-active components, and by the diffusion of hydrogen through the noble metal-comprising component. If, owing to the complex processes which result from the particle flows of, e.g., water, the redox-active components, oxygen, and hydrogen, the oxygen partial pressure becomes too high locally, oxygen bubbles will arise locally.

FIGS. 2a and 2b illustrate, by way of exemplary schematic views, the local oxygen partial pressures arising in a glass melt at a noble metal-comprising component. Here, the case of producing glass tubes from an alkaline earth-containing borosilicate glass was considered, by way of example.

In this exemplary case, the noble metal-comprising component is provided in the form a stirring crucible having a lateral inlet and an outlet at the bottom. The stirrer shaft and stirring blades are not shown. By way of example, a glass composition according to Exemplary Embodiment 7 was considered.

More generally, however, without being limited to the example of the glass tube made of alkaline earth-containing borosilicate glass which is considered here, the method of the present invention is likewise useful for producing sheet glass or glass rods. Other glasses, for example boron-free, alkali-free, and/or alkaline earth-free glasses, can also be produced by the present method.

FIG. 2a illustrates regions 4 of critical oxygen partial pressures. Here, the regions 4 at the component, in which the oxygen partial pressure assumes critical values are indicated by arrows.

FIG. 2b is a further view of the noble metal-comprising component. Here, the oxygen partial pressures prevailing on the noble metal-comprising component are shown by way of example, with regions of equal pressures being marked by “contour lines” as shown by the scale on the right side of FIG. 2b.

It can be clearly seen from both views that a critical increase in oxygen partial pressure is existent only at a few locations in the present example. Therefore, an appropriate countermeasure for reducing water decomposition and hence the oxygen bubbles resulting therefrom has to be taken only at these sites.

It is particularly advantageous if gases are used which include no H₂ at all. Otherwise, in noble metals which exhibit high H₂ resorption capability, for example platinum or platinum-containing alloys, the hydrogen, through diffusion processes, could even reach the locations at the component-glass melt interface where no critical oxygen concentrations are prevailing. A drawback thereof would be that hydrogen could react with redox-active substances in the melt, such as iron or sulfur impurities or oxidic refining agents such as SnO₂, and could cause alloying of the noble metal especially at locations of the component which are non-critical in terms of oxygen bubble formation, which alloying would reduce the service life of the component.

The preferred countermeasure for suppressing locally limited oxygen bubble formation consists in glazing of the noble metal-comprising component. If this is not possible for reasons of mechanical stability, the preferred countermeasure consists in a locally limited supply of water on the outer surface of the noble metal-comprising component. In this case, it is particularly preferred to utilize a carrier gas that is moisturized in controlled manner, i.e. a gas with a dew point adjusted in controlled manner. By selectively adjusting the dew point, the effect of the supplied water can be controlled selectively, and on the other hand it is possible to minimize the formation of volatile noble metal oxides by controlling the oxygen content. For this purpose, the O₂ content of the carrier gas can be monitored using an atmosphere sensing ZrO₂ probe.

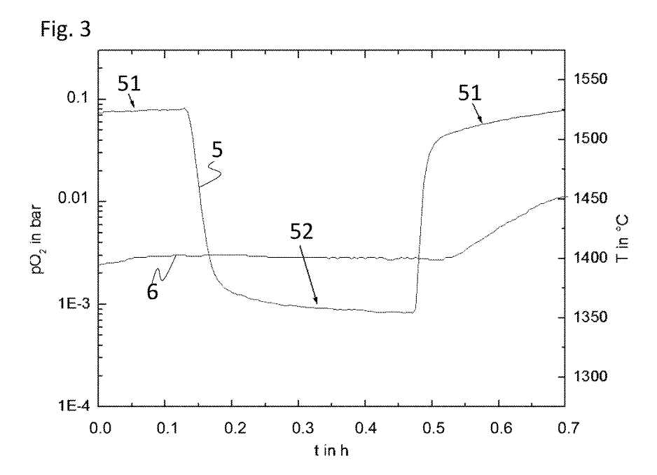

FIG. 3 shows, by way of example, the profile of oxygen partial pressure at the component-glass melt interface during flushing with different carrier gases.

The left y-coordinate represents the oxygen partial pressure at the noble metal-comprising component. Curve 5 shows the oxygen partial pressure in the melt at the interface between component and glass melt as a function of time indicated along the x-axis.

Curve 6 gives the temperature profile at the component-glass melt interface over time, the temperature being represented by the right y-coordinate, in ° C.

It can clearly be seen that moistened air may lead to a non-critical oxygen partial pressure of less than 0.1 bar at the component-glass melt interface, when the dew point is appropriately high (see sections 51 of curve 5). In the present example, the dew point was set to 60° C. When flushing is changed from moistened air to moistened nitrogen and the dew point remains the same, i.e. also 60° C. in the present case by way of example, the oxygen partial pressure at the interface between the component and the glass melt will further decrease markedly, as can be seen from section 52 of curve 5.

This illustrates that the use of a moistened carrier gas which itself does not contain molecular oxygen has two advantages. On the one hand, the lowering of the local oxygen partial pressure at the interface between component and glass melt is more pronounced. On the other hand, oxidation of the at least one noble metal in the noble metal-comprising component is drastically reduced on the outer surface of the component, that is on the side facing away from the melt. This results in a longer service life.

If the locally delimited sites at the noble metal-comprising component which have to be appropriately protected are known, the use of the moistened carrier gas can be limited to these locations. In addition, the noble metal may be further protected locally at these sites by particularly effective coatings or by a locally limited increase of the wall thickness. If the increase in wall thickness has to be provided only locally, however, even cost-effectiveness of such a measure is given.

Thus it is possible according to the method to both reduce or even completely suppress the formation of oxygen bubbles and on the other hand maximize the service life of the noble metal-comprising component, by a combination of determining the locally delimited sites at which a critical increase of the oxygen partial pressure arises and therefore increased bubble formation occurs, and the countermeasures which then only have to be implemented locally.

### LIST OF REFERENCE NUMERALS

1 Gas chamber
2 Noble metal-comprising component
3 Glass melt zone
4 Regions of glass melt with oxygen partial pressure critical for bubble formation
5 Curve of oxygen partial pressure at the component-glass melt interface versus time
51 Section of curve 5 with air as the carrier gas
52 Section of curve 5 with nitrogen as the carrier gas
6 Curve of temperature at the component-glass melt interface versus time

What is claimed is:

1. A method for producing a glass product having a low bubble content from a melt, comprising:
contacting the melt with a noble metal-comprising component at a location, the melt having a temperature-dependent oxygen partial pressure that varies locally over a volume of the melt up to a critical value; and
implementing, at the location where the noble metal-comprising component is in contact with the melt, at least one measure, only locally, on the noble metal-comprising component, the at least one measure being selected from the group consisting of:
coating a side of the noble metal-comprising component that faces away from the melt;
exposing the side of the noble metal-comprising component that faces away from the melt to a water-containing atmosphere; and
increasing a thickness of the noble metal-comprising component.

2. The method as claimed in claim 1, wherein the coating is a glass.

3. The method as claimed in claim 1, wherein the water-containing atmosphere is a water-containing protective gas atmosphere.

4. The method as claimed in claim 1, wherein the water-containing atmosphere comprises N₂ and/or noble gas.

5. The method as claimed in claim 1, wherein the critical value is between 0.8 bar and 1.2 bar.

6. The method as claimed in claim 1, wherein the critical value is between 0.9 bar and 1.1 bar.

7. The method as claimed in claim 1, further comprising initially identifying the location at the noble metal-comprising component where the oxygen partial pressure locally reaches the critical value.

8. The method as claimed in claim 1, wherein the noble metal-comprising component comprises a stirring crucible having a tubular inlet and an outlet, and wherein the step of implementing the at least one measure is performed at the inlet and/or at the outlet.

9. The method as claimed in claim 1, wherein the noble metal-comprising component comprises one or more noble metals selected from the group consisting of platinum, rhodium, iridium, osmium, rhenium, ruthenium, palladium, gold, silver, and mixtures or alloys thereof.

10. The method as claimed in claim 1, further comprising adjusting a dew point in the water-containing atmosphere to between 20° C. and 90° C.

11. The method as claimed in claim 1, further comprising adjusting a dew point in the water-containing atmosphere to between 20° C. and 70° C.

12. The method as claimed in claim 1, further comprising adjusting a dew point in the water-containing atmosphere to between 30° C. and 65° C.

13. The method as claimed in claim 1, wherein the water-containing atmosphere has a temperature-dependent oxygen partial pressure of less than 0.1 bar.

14. The method as claimed in claim 1, wherein the water-containing atmosphere has a temperature-dependent oxygen partial pressure of less than 0.01 bar.

15. The method as claimed in claim 1, wherein the water-containing atmosphere has a temperature-dependent oxygen partial pressure of less than 0.001 bar.

16. The method as claimed in claim 1, further comprising forming the melt so that the glass product is a product selected from the group consisting of a glass tube, a glass rod, and a sheet glass.

17. The method as claimed in claim 1, further comprising forming the melt so that the glass product comprises a glass selected from the group consisting of a borosilicate glass, an alkaline earth-free or an alkaline earth-containing borosilicate glass, an alkali-alkaline earth silicate glass, a boron-free glass, a boron-free neutral glass, a low-alkali glass, an alkali-free glass, a low-arsenic glass, and an arsenic-free glass.

18. The method as claimed in claim 1, further comprising forming the melt so that the glass product comprises a glass pharmaceutical package.
